(19) United States
(12) Patent Application Publication
(10) Pub. No.: US 2025/0117171 A1
(43) Pub. Date: Apr. 10, 2025

(54) SERVER APPARATUS FOR MANAGING IMAGE FORMING APPARATUS, MANAGEMENT SYSTEM, AND COMPUTER-READABLE STORAGE MEDIUM

(71) Applicant: CANON KABUSHIKI KAISHA, Tokyo (JP)

(72) Inventors: Marehiko Hirajima, Kanagawa (JP); Kengo Kawamoto, Kanagawa (JP)

(21) Appl. No.: 18/889,842

(22) Filed: Sep. 19, 2024

(30) Foreign Application Priority Data
Oct. 10, 2023 (JP) 2023-175546

(51) Int. Cl. G06F 3/12

(52) U.S. Cl. CPC G06F 3/1261; G06F 3/1205

(57) ABSTRACT

A server apparatus includes a storage unit configured to store information indicating a first maximum number of sheets that can be printed in color during a predetermined period using a target apparatus, information indicating a second maximum number of sheets that can be printed in monochrome during the predetermined period using the target apparatus, information indicating the number of sheets printed in color using the target apparatus in the predetermined period, and information indicating the number of sheets printed in monochrome using the target apparatus in the predetermined period; and a processing unit configured to, in response to a first request for changing at least one of the first and the second maximum number of sheets received from a terminal used by a user, perform change processing for changing the at least one of the first and the second maximum number of sheets.

### BACKGROUND OF THE INVENTION

### Field of the Invention

The present invention relates to a technique for managing a subscription service related to an image forming apparatus.

### Description of the Related Art

US-2022-0334510 discloses a subscription service related to an image forming apparatus. In the following description, the subscription service is also referred to simply as the “service”. According to US-2022-0334510, the maximum number of sheets, which is the maximum number of printed sheets to be allowed within a certain period, is set in a contract for using the service. Then, when the number of sheets printed within that certain period by a user using the service is less than or equal to the set maximum number of sheets, the user is charged a flat rate.

US-2022-0334510 does not disclose a configuration for the user to change contract contents such as the maximum number of sheets. However, the number of sheets printed by the user may vary due to business cycles, sudden demand, and the like. Therefore, it is desired that the user can flexibly register or change contract contents such as the maximum number of sheets. In particular, a user who uses an image forming apparatus capable of color printing can only print up to a predetermined number of sheets for color printing and monochrome printing, and there is a demand for being able to register or change contract contents more flexibly.

### SUMMARY OF THE INVENTION

According to an aspect of the present invention, a server apparatus configured to manage an image forming apparatus, includes: a storage unit configured to store information indicating a target image forming apparatus used by a user, information indicating a first maximum number of sheets that can be printed in color during a predetermined period using the target image forming apparatus, information indicating a second maximum number of sheets that can be printed in monochrome during the predetermined period using the target image forming apparatus, information indicating the number of sheets printed in color using the target image forming apparatus in the predetermined period, and information indicating the number of sheets printed in monochrome using the target image forming apparatus in the predetermined period; and a processing unit configured to, in response to a first request for changing at least one of the first maximum number of sheets and the second maximum number of sheets received from a terminal used by the user, perform change processing for changing the at least one of the first maximum number of sheets and the second maximum number of sheets.

Further features of the present invention will become apparent from the following description of exemplary embodiments with reference to the attached drawings.

### BRIEF DESCRIPTION OF THE DRAWINGS

FIG. 1 is a diagram of a schematic configuration of an image forming apparatus according to some embodiments.

FIG. 2 is a diagram of a configuration of a developing unit of an image forming apparatus according to some embodiments.

FIGS. 3A to 3C are diagrams for explaining a cartridge replacement procedure according to some embodiments.

FIG. 4 is a diagram of a configuration of a management system according to some embodiments.

FIG. 5 is a diagram of a configuration of a management server according to some embodiments.

FIG. 6 is a diagram illustrating an example of a screen to be displayed on a user terminal according to an embodiment.

FIG. 7 is a sequence diagram of processing for changing contract contents according to one embodiment.

FIGS. 8A and 8B are diagrams illustrating examples of screens to be displayed on the user terminal in the processing for changing contract contents according to one embodiment.

FIGS. 9A and 9B are diagrams illustrating examples of screens to be displayed on the user terminal in the processing for changing contract contents according to one embodiment.

FIG. 10 is a diagram illustrating an example of a screen to be displayed on the user terminal in the processing for changing contract contents according to one embodiment.

FIG. 11 is a diagram illustrating an example of a screen to be displayed on the user terminal according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Each of the following embodiments are applicable to a subscription service related to an image forming apparatus such as a copy machine, a printer, a facsimile receiver, and a multifunction peripheral. In the following, each embodiment will be described based on an electrophotographic image forming apparatus in which toner is used as a coloring material. However, the image forming apparatus may be, for example, an image forming apparatus for forming an image using another type of coloring material such as an inkjet printer, which uses ink as a coloring material.

### First Embodiment

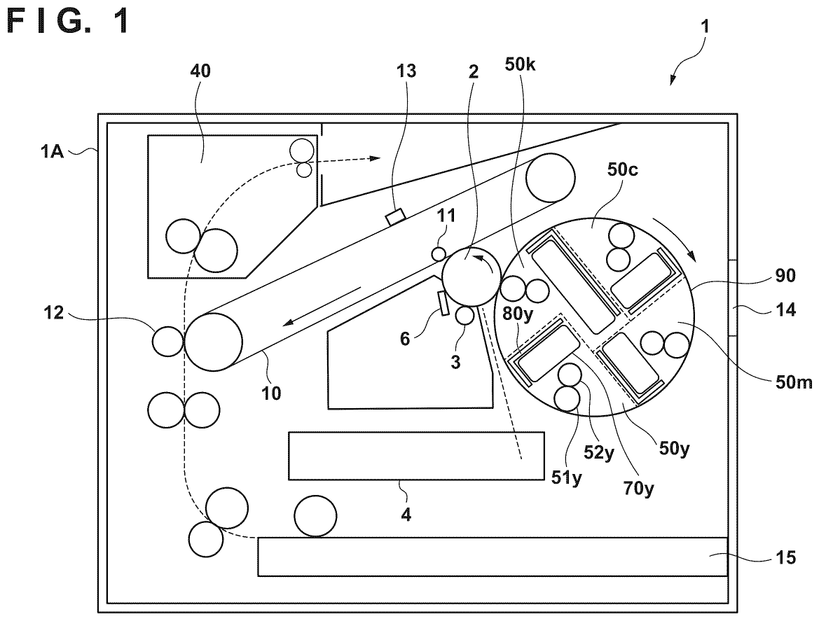

FIG. 1 is a schematic cross-sectional view of an image forming apparatus 1 according to the present embodiment. A photosensitive body 2 is rotationally driven in a counterclockwise direction of FIG. 1 at the time of image formation. A charging roller 3 charges the surface of the photosensitive body 2. An exposure apparatus 4 exposes the photosensitive body 2 based on image information to form an electrostatic latent image on the photosensitive body. A rotary 90, which includes developing units 50y, 50m, 50c and 50k, is configured to be rotatable in a clockwise direction in FIG. 1.

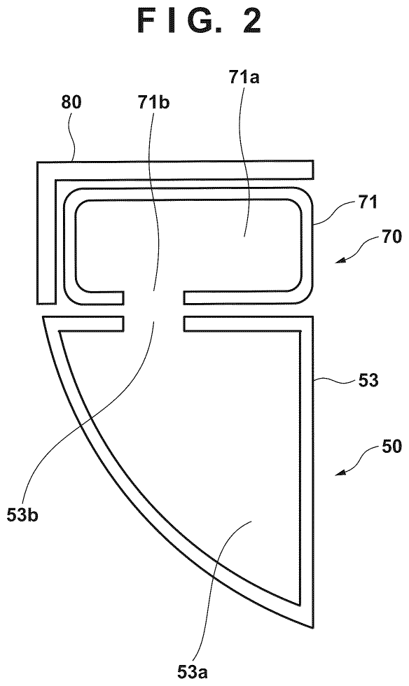

Since the configurations of the developing units 50y, 50m, 50c and 50k are similar, the configuration of the developing unit 50y will be described as a representative in the following. A tray 80y is coupled to the rotary 90 and is configured to be movable in a radial direction of the rotary 90. A cartridge 70y is mounted on the tray 80y. The cartridge 70y is a storage member for storing yellow toner. The cartridge 70y supplies the toner to a toner storage unit 53a (FIG. 2) in the developing unit 50y. A supply roller 52y supplies the toner of the toner storage unit 53a to a developing roller 51y. The developing roller 51y forms a yellow toner image on the photosensitive body 2 by developing the electrostatic latent image of the photosensitive body 2 with the yellow toner when the rotary 90 rotates to face the photosensitive body 2. Hereinafter, an orientation of the rotary 90 in which the developing roller 51y of the developing unit 50y faces the photosensitive body 2 is referred to as a yellow developing orientation. Regarding the developing units 50m, 50c and 50k, a magenta developing orientation, a cyan developing orientation, and a black developing orientation are defined, similarly to the developing unit 50y. The magenta developing orientation, the cyan developing orientation, and the black developing orientation are orientations of the rotary 90 in which the developing units 50m, 50c and 50k can respectively develop an electrostatic latent image of the photosensitive body 2.

As described above, since the configurations of the developing units 50y, 50m, 50c and 50k are similar, the developing units 50y, 50m, 50c and 50k are collectively referred to as the developing unit 50 in the following. Respective components of the developing unit 50 are also collectively referred to as the tray 80, the cartridge 70, the supply roller 52, and the developing roller 51. The size of the cartridge 70 need not be the same for each color. For example, yellow, cyan and magenta toners are used only in color printing, while black toner is used in both monochrome printing and color printing. Therefore, in general, the black toner consumption is higher than yellow, cyan, and magenta toner consumption. Thus, the cartridge 70 storing black toner may be configured such the size is larger than those of the cartridges 70 storing other colors of toner to store a larger amount of toner.

A primary transfer roller 11 transfers a toner image formed on the photosensitive body 2 to an intermediate transfer belt 10. A cleaning unit 6 removes, from the photosensitive body 2, toner that was not transferred to the intermediate transfer belt 10 and remaining on the photosensitive body 2. The intermediate transfer belt 10 is rotationally driven in the clockwise direction of FIG. 1 at the time of image formation. When a color image is formed, for example, a yellow toner image is formed on the photosensitive body 2 with the rotary 90 at the yellow developing orientation and transferred to the intermediate transfer belt 10. Then, a magenta toner image is formed on the photosensitive body 2 with the rotary 90 at the magenta developing orientation. The yellow toner image transferred to the intermediate transfer belt 10 is conveyed to a position facing the photosensitive body 2 again with the rotation of the intermediate transfer belt 10. The magenta toner image on the photosensitive body 2 is transferred so as to overlap the yellow toner image transferred to the intermediate transfer belt 10. Thereafter, similarly, the cyan toner image and the black toner image formed on the photosensitive body 2 are sequentially transferred so as to overlap the toner images on the intermediate transfer belt 10. Thus, a color toner image is formed on the intermediate transfer belt 10.

A secondary transfer roller 12 transfers a color toner image formed on the intermediate transfer belt 10 to a sheet conveyed from a cassette 15. A cleaning apparatus 13 removes, from the intermediate transfer belt 10, toner that was not transferred to the sheet and remaining on the intermediate transfer belt 10. The secondary transfer roller 12 and the cleaning apparatus 13 are separated from the intermediate transfer belt 10 until the color toner image to be transferred to a sheet is formed on the intermediate transfer belt 10. When a monochrome image is formed, a black toner image is formed on the photosensitive body 2 at the black developing orientation, transferred to the intermediate transfer belt 10, and further transferred to a sheet.

A fixing apparatus 40 heats and presses a sheet to which a toner image has been transferred, thereby fixing the toner image onto the sheet. After the toner image has been fixed, the sheet is discharged out of the image forming apparatus 1. A door 14 for replacing the cartridge 70 is provided on a surface of a main body 1A of the image forming apparatus 1 that faces the rotary 90.

FIG. 2 is a diagram for explaining a configuration of the developing unit 50. To simplify the drawing, the supply roller 52 and the developing roller 51 are omitted in FIG. 2. The developing unit 50 includes a frame 53. The inner space of the frame 53 constitutes the toner storage unit 53a. The supply roller 52 and the developing roller 51 are provided in the toner storage unit 53a. The frame 53 is provided with an opening 53b for supplying the toner storage unit 53a with toner from the cartridge 70. The inside of a frame 71 of the cartridge 70 constitutes a toner storage unit 71a for storing toner. The frame 71 is provided with an opening 71b for supplying the toner storage unit 53a with toner. The developing unit 50 is configured such that the opening 71b faces the opening 53b while the cartridge 70 is mounted on the developing unit 50. When the toner storage unit 53a is positioned below the cartridge 70, toner is supplied to the toner storage unit 53a from the cartridge 70.

Configuration may be taken so as to provide a sealing member covering the opening 71b in the cartridge 70. Similarly, configuration may be taken so as to provide a sealing member covering the opening 53b in the frame 53. By providing the sealing members at the opening 71b and the opening 53b, leakage of toner is prevented in a state in which the cartridge 70 is not mounted on the developing unit 50.

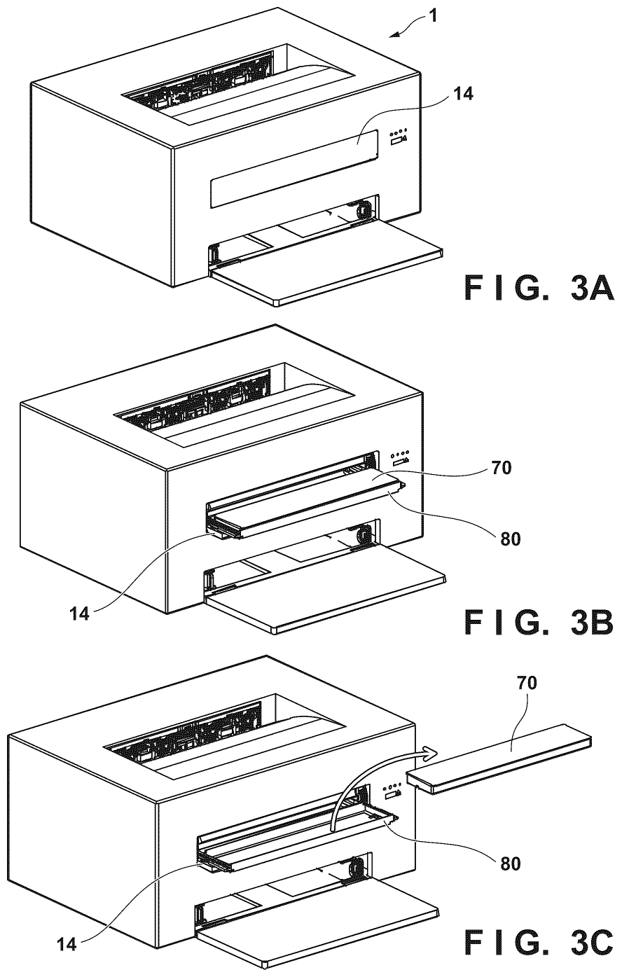

FIGS. 3A to 3C are diagrams for explaining processing for replacing the cartridge 70. FIG. 3A illustrates the image forming apparatus 1 in an image forming operation or a standby state, and the door 14 is in a closed state. A control unit of the image forming apparatus 1 is configured to be capable of detecting the remaining amount of toner stored in the cartridge 70 or the toner storage unit 53a by a remaining amount detection mechanism (not illustrated). The control unit is configured to be capable of notifying the user for each cartridge 70 that the remaining amount of toner is a predetermined value, which is a guideline for replacement, or that the cartridge 70 needs to be replaced based on a result of detection of the remaining amount of toner. When replacing the cartridge 70 based on that notification, the user instructs the control unit to perform a cartridge replacement operation through an input interface such as an operation panel.

In response to an instruction for the cartridge replacement operation, the control unit rotates the rotary 90 to cause the cartridge 70 to be replaced to face the door 14. Then, the control unit moves the tray 80 supporting the cartridge 70 to be replaced in a radial direction, that is, in a direction toward the door 14. Thus, as illustrated in FIG. 3B, the door 14 enters an open state by being pushed by the tray 80, and the tray 80 and the cartridge 70 supported by the tray 80 protrude out of the image forming apparatus 1. Thus, the user can replace the cartridges 70 as illustrated in FIG. 3C.

The control unit may be configured to not accept an instruction for the cartridge replacement operation until the remaining amount of toner is less than or equal to the predetermined value. Alternatively, configuration may be taken such that the cartridge 70 is provided with an attachable/detachable lock mechanism and the control unit controls the attachable/detachable lock mechanism so that the cartridge 70 cannot be replaced until the remaining amount of toner is less than or equal to the predetermined value. The predetermined value may be 0. With this configuration, it is possible to reduce the amount of toner discarded without being consumed.

### <Management System>

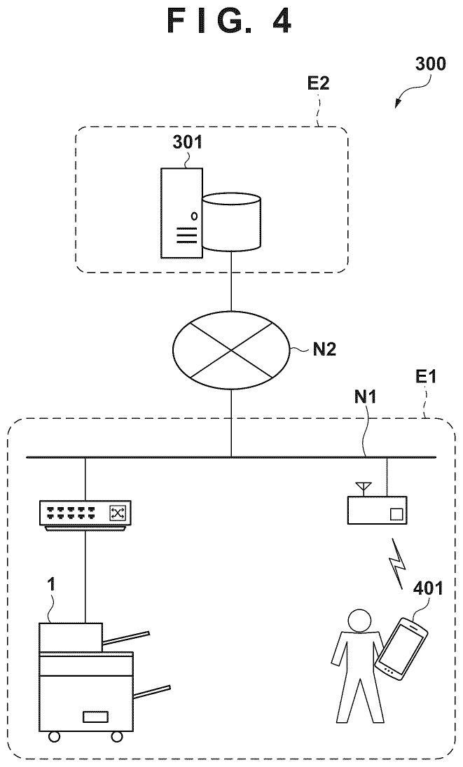

FIG. 4 is a diagram of a configuration of a management system 300 according to the present embodiment. The management system 300 includes the image forming apparatus 1, a management server 301, and a user terminal 401. The management server 301 is operated, for example, by a business operator (service provider) that provides a subscription service or by a business operator under the management of the service provider. The image forming apparatus 1 is an apparatus used by a user who has concluded a contract (hereinafter, referred to as service contract) for using the service with the service provider, and the user terminal 401 is an information terminal used by the user.

The image forming apparatus 1 is installed in a user environment E1 in which the user is present. The image forming apparatus 1 and the user terminal 401 are connected to a local network N1. The local network N1 may be, for example, a Local Area Network (LAN). In the user environment E1, the user uses the image forming apparatus 1. As described above, the image forming apparatus 1 forms an image on a sheet using toner as a coloring material.

The management server 301 is installed in an environment (remote environment E2) that is remote from an environment (user environment E1) in which the image forming apparatus 1 is installed. The remote environment E2 is connected to the local network N1 via an external network N2. The external network N2 may be, for example, the Internet or a Virtual Private Network (VPN). The local network N1 and the external network N2 may each include any type of network apparatus, such as a router, a switch, a gateway, a wireless access point, and a base station, for example. The local network N1 and the external network N2 may each include any number of network apparatuses. In this way, the image forming apparatus 1, the management server 301, and the user terminal 401 are configured to be capable of communicating with each other.

In the present embodiment, the management server 301 is a server apparatus for managing the image forming apparatus 1. For example, the management server 301 manages the number of printed sheets (number of pages) which is the number of sheets on which image formation has been performed in the image forming apparatus 1, user account information, and the like. The management server 301 may be implemented as an application server, a database server, or a cloud server using a general-purpose computer, for example.

The user terminal 401 is a terminal apparatus that provides the user with a user interface for supporting a management function of the management server 301. The user terminal 401 may be a general-purpose terminal apparatus such as a smartphone, a cellular phone, a Personal Computer (PC), or a Personal Digital Assistant (PDA), for example. The image forming apparatus 1 may also provide the user with a user interface.

The functions of the management server 301 may be provided by a single apparatus or may be provided by a plurality of physically separate apparatuses cooperating with each other. Part of a database described as being held by the management server 301 may be held by an external apparatus (e.g., another database server) separate from the management server 301.

### <Configuration of Management Server>

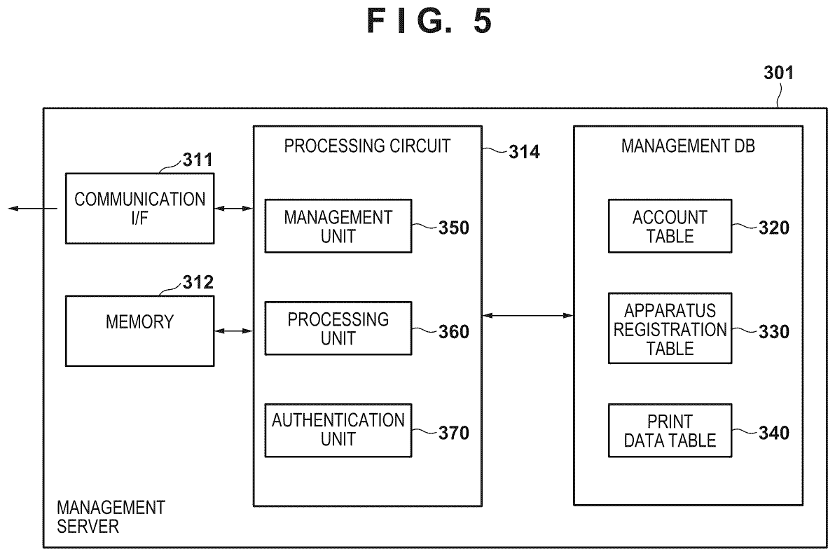

FIG. 5 is a block diagram illustrating an example of a configuration of the management server 301 according to the present embodiment. A communication I/F 311 is a communication interface for communication via the external network N2. The communication I/F 311 may be a wired communication interface or may be a wireless communication interface. A memory 312 may include any type of storage medium, such as a semiconductor memory (Read Only Memory (ROM), Random Access Memory (RAM), etc.), an optical disk, or a magnetic disk, for example. The memory 312 may include a non-transitory computer-readable storage medium. The memory 312 stores one or more computer programs to be executed by a processing circuit 314 and various kinds of data such as data to be used by the processing circuit 314.

A management database (DB) 313 includes an account table 320, an apparatus registration table 330, and a print data table 340. In the subscription service of the present embodiment, when the number of printed sheets in the image forming apparatus 1 in a predetermined period is less than or equal to the maximum number of sheets defined in the service contract, the user is charged a flat rate regardless of the number of printed sheets. In the following description, the predetermined period is one month as an example. The following information included in respective tables in the management DB 313 is associated with the service contract.

The account table 320 is a table that holds information related to accounts of users. The account table 320 may include, for example, one or more of the following items:
“user ID”
“password”
“user name”
“email address”
“address”
“contracted number of sheets for color”
“contracted number of sheets for monochrome”
“payment method”
“serial number (serial No)”

The “user ID” is identification information for uniquely identifying an

account of a respective user. The “password” is used in user authentication for when the user logs in to the system. The “user name” represents the user name of a respective account. The user name is displayed on a screen after login, for example. The “email address” is destination information used as a destination of various notifications from the system to a respective user in an email message. The “address” is used, for example, as a delivery destination of the cartridge 70. The “contracted number of sheets for color” indicates a maximum value for the number of sheets to be printed, which can be printed in color at a flat rate within the predetermined period (one month in this example). The “contracted number of sheets for monochrome” indicates a maximum value for the number of sheets to be printed, which can be printed in monochrome at a flat rate within the predetermined period (one month in this example). In the following description, the contracted number of sheets for color and the contracted number of sheets for monochrome are collectively referred to as the contracted number of sheets. The “payment method” indicates a method of paying compensation for the service. The “serial number” indicates identification information that can be used as a search key to identify a user ID.

The apparatus registration table 330 is a table that holds information related to the image forming apparatus 1 (service target image forming apparatus) used by a respective user in the service. The apparatus registration table 330 may include, for example, one or more of the following items:
“apparatus ID”
“owner”
“registration date”
“status”

The “apparatus ID” is identification information for identifying the image forming apparatus 1. For example, the “apparatus ID” may be information for identifying a type of the image forming apparatus 1. Alternatively, the “apparatus ID” may be information with which an individual image forming apparatus 1 can be identified in addition to a type thereof. The “owner” indicates, using the “user ID” registered in the account table 320, the account of a user using the image forming apparatus 1 identified by the “apparatus ID”. A pair of the “owner” and the “apparatus ID” indicates an association between the account of a user and the image forming apparatus 1 used by that user. The “registration date” indicates a date on which the “apparatus ID” of the image forming apparatus 1 was registered in the apparatus registration table 330. The “status” indicates a status related to verification as to whether the image forming apparatus 1 is actually installed in the user environment E1 of the “owner”. At the time of initial registration of the “apparatus ID”, the “status” indicates “unverified”, and when the verification is completed, the “status” is changed to “verified”. The verification can be performed by the management server 301 communicating with the image forming apparatus 1 installed in the user environment E1. The image forming apparatus 1 used in the service can be provided by the service provider to the user as a leased product or a rental product. Alternatively, the image forming apparatus 1 used in the service may be a user-owned apparatus purchased by the user.

The print data table 340 is a table that holds data related to printing. The print data table 340 may include, for example, one or more of the following items:
“number of used pages (monochrome)”
“number of used pages (color)”
“number of available pages (monochrome)”
“number of available pages (color)”

The “number of used pages (monochrome)” and the “number of used pages (color)” indicate the number of sheets printed in monochrome and the number of sheets printed in color, respectively, in the current predetermined period, that is, the current month in this example. The “number of available pages (monochrome)” and the “number of available pages (color)” indicate the number of sheets to be printed for monochrome and the number of sheets to be printed for color, respectively, that can be printed within a flat rate from the current time to the end of the current month.

Although not illustrated, the management server 301 also includes a table for managing the amount of remaining toner of the image forming apparatus 1 obtained from the image forming apparatus 1. The table can be used for delivery of cartridges to the user.

The processing circuit 314 may be, for example, a Central Processing Unit (CPU). The processing circuit 314 provides functions included in the management server 301 by executing a computer program stored in the memory 312. More specifically, as illustrated in FIG. 5, the processing circuit 314 may function as a management unit 350, a processing unit 360, and an authentication unit 370.

The management unit 350 manages processing in the processing unit 360 and the authentication unit 370 and performs processing related to communication with the user terminal 401 and the image forming apparatus 1. The authentication unit 370 performs login authentication for the user to log in to the management system 300. For example, the management unit 350 causes the user terminal 401 to display a login screen for accepting input of a user ID and a password and receives the user ID and the password from the user terminal 401 through the communication I/F 311. The authentication unit 370 performs user authentication using the received user ID and password and a user ID and a password stored in the account table 320.

The processing unit 360 manages data registration and update for the management DB 313. For example, the management unit 350 may cause the user terminal 401 to display a screen for accepting changes in the “contracted number of sheets for color” and the “contracted number of sheets for monochrome” registered in the account table 320. In that case, the management unit 350 receives information indicating the inputted changed “contracted number of sheets for color” and “contracted number of sheets for monochrome” from the user terminal 401 through the communication I/F 311. The processing unit 360 may update the “contracted number of sheets for color”, the “contracted number of sheets for monochrome”, and the like of the account table 320 based on the received information.

Further, the management unit 350 repeatedly obtains information related to the number of printed sheets and the remaining amount of toner from the image forming apparatus 1. The processing unit 360 updates the print data table 340 and the table for managing the remaining amount of toner based on the information related to the number of printed sheets and the remaining amount of toner.

The input screens to be displayed on the user terminal 401 by the management unit 350 may be provided in any form, for example, a web page, an input form, an application screen, or the like. For example, the acceptance of various inputs in the user terminal 401 may be performed when user authentication using a user ID and a password stored in the account table 320 is successful and while the user is logged in to the management system 300 (management server 301).

### <Example of GUI>

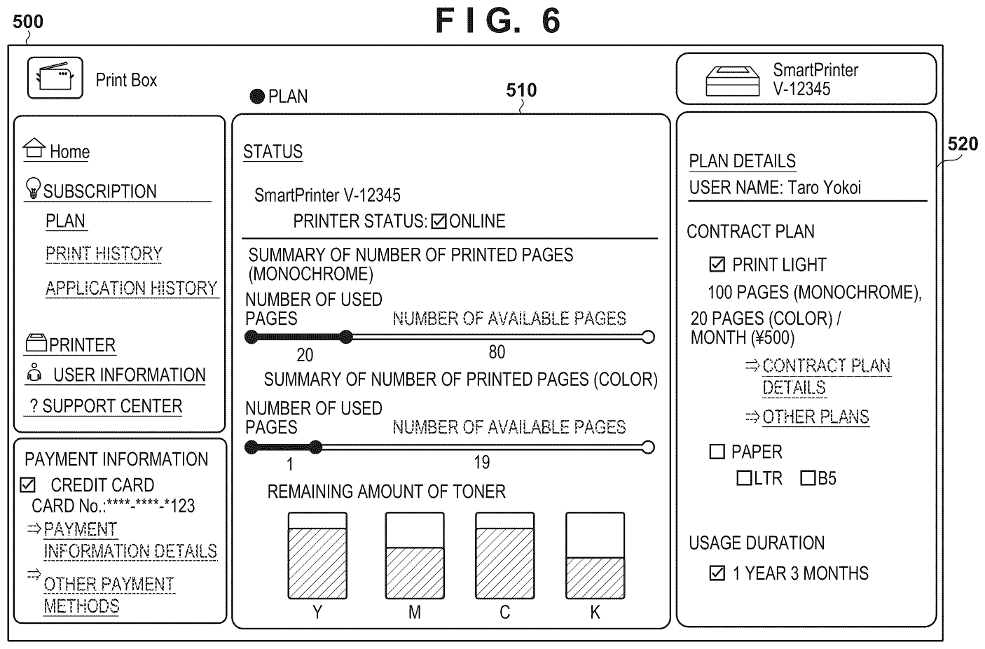

FIG. 6 illustrates a screen 500, which is an example of a Graphical User Interface (GUI) provided by the management server 301 and displayed on a display unit of the user terminal 401. The screen 500 is displayed on the display unit of the user terminal 401 when the user (contract user) logs in to the management system 300 using the user terminal 401. The screen 500 displays information held in the management DB 313 of the management server 301. The information displayed in the screen 500 includes contract contents of the service. The screen 500 includes regions 510 and 520. The region 510 displays information of items included in the apparatus registration table 330 and the print data table 340. The region 520 displays information of items included in the account table 320. The screen 500 is configured to allow the user to confirm information managed by the management server 301 through the screen. In addition, the screen 500 is configured such that the user can change contract contents (contract plan) through the screen.

The region 520 indicates that in the current contract plan, the contracted number of sheets for monochrome printing is 100 sheets per month and the contracted number of sheets for color printing is 20 sheets per month. Further, the region 510 indicates that 20 sheets of monochrome printing and one sheet of color printing have already been performed and that the remaining number of sheets to be printed for monochrome is 80 sheets, and the remaining number of sheets to be printed for color is 19 sheets. Further, the screen 500 indicates the remaining amount of toner in the cartridge 70 of each color.

### <Processing for Changing Contract Contents>

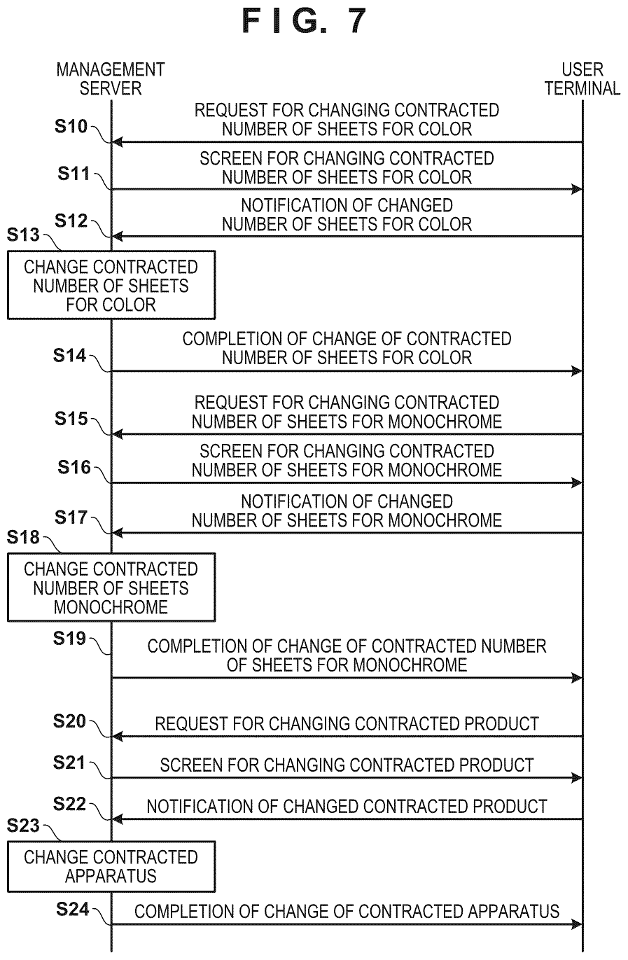

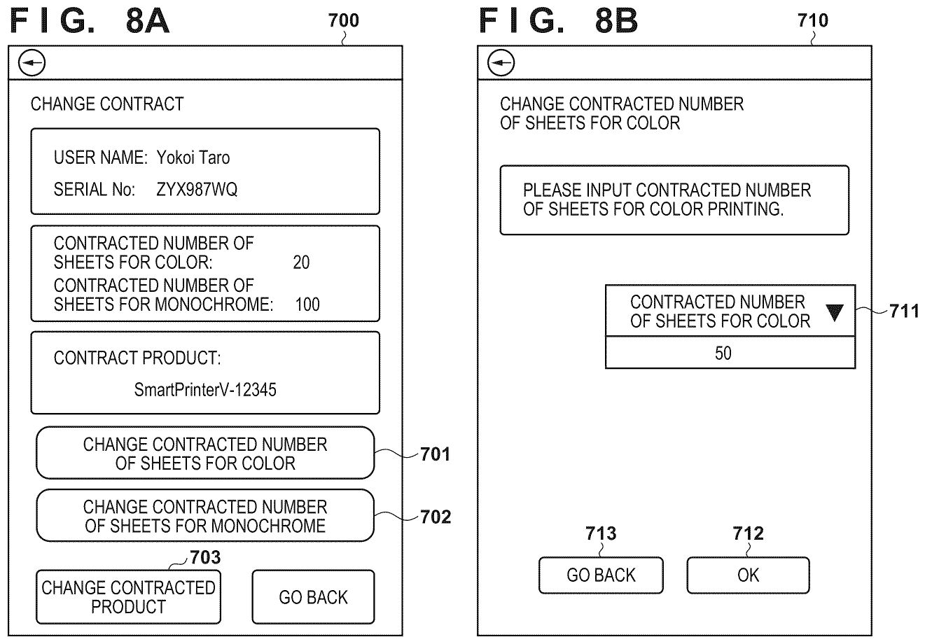

FIG. 7 is a sequence diagram of processing for a change of contract contents performed by the user. At the start of the processing of FIG. 7, it is assumed that the user logs in to the system, and according to operations on the user terminal 401 thereafter, the user terminal 401 displays a contract change screen 700 illustrated in FIG. 8A. According to FIG. 8A, the contract change screen 700 indicates that the current contracted number of sheets for color is 20 sheets and the current contracted number of sheets for monochrome is 100 sheets. The contracted number of sheets for color and the contracted number of sheets for monochrome displayed on the contract change screen 700 are registered in the account table 320. Further, the contract change screen 700 displays information about the image forming apparatus 1 used by the user in the service as a contracted product (contracted apparatus). The contracted product indicates a type (model) of the image forming apparatus 1 registered in the “apparatus ID” of the apparatus registration table 330. According to FIG. 8A, the user uses a type of the image forming apparatus 1 named “SmartPrinterV-12345”. Further, information stored in the “user name” and the “serial number” of the account table 320 is displayed as a user name and a serial No on the contract change screen 700. According to FIG. 8A, the user name is “Yokoi Taro”, and the serial No is “ZYX987WQ”.

In response to the user selecting a change contracted number of sheets for color object 701, in step S10 the user terminal 401 transmits a request for changing the contracted number of sheets for color to the management server 301. In response to receiving the request for changing the contracted number of sheets for color, in step S11 the management unit 350 of the management server 301 transmits a screen for changing the contracted number of sheets for color to the user terminal 401 and causes the user terminal 401 to display the screen. FIG. 8B indicates an example of a screen 710 for changing the contracted number of sheets for color. By the user operating an object 711, which is a pull-down menu, options for the number of sheets available for contract are displayed, and the user selects a desired contracted number of sheets from the displayed options. In FIG. 8B, the user has selected 50 sheets as the changed contracted number of sheets for color. Then, in response to the user operating an object 712, in step S12 the user terminal 401 notifies the management server 301 of information indicating the changed contracted number of sheets for color. Configuration may be taken such that when the changed contracted number of sheets for color is the same as the contracted number of sheets for color before the change, the user terminal 401 notifies the user that the contracted number of sheets has not been changed in response to an operation of the object 712. In this case, the user terminal 401 may display the screen of FIG. 8B without notifying the management server 301 of the information indicating the changed contracted number of sheets for color. Further, when the user operates an object 713, the user terminal 401 displays the screen of FIG. 8A without notifying the management server 301 of the information indicating the changed contracted number of sheets for color.

In step S13, the processing unit 360 of the management server 301 changes the “contracted number of sheets for color” of the account table 320 to the number indicated by the information received in step S12. In addition, the processing unit 360 updates “number of available pages (color)” of the print data table 340 accordingly. When the update of the account table 320 and the print data table 340 by the processing unit 360 is completed, in step S14 the management unit 350 of the management server 301 makes a change completion notification to the user terminal 401. Such a notification includes information to be displayed on the screen of FIG. 8A based on the changed contract contents. Upon receiving the change completion notification from the management server 301, the user terminal 401 may display the contract change screen 700 illustrated in FIG. 8A based on the information received in the change completion notification. In the contracted number of sheets for color of the contract change screen 700, the changed contracted number of sheets, that is, 50 sheets in the above example, is displayed.

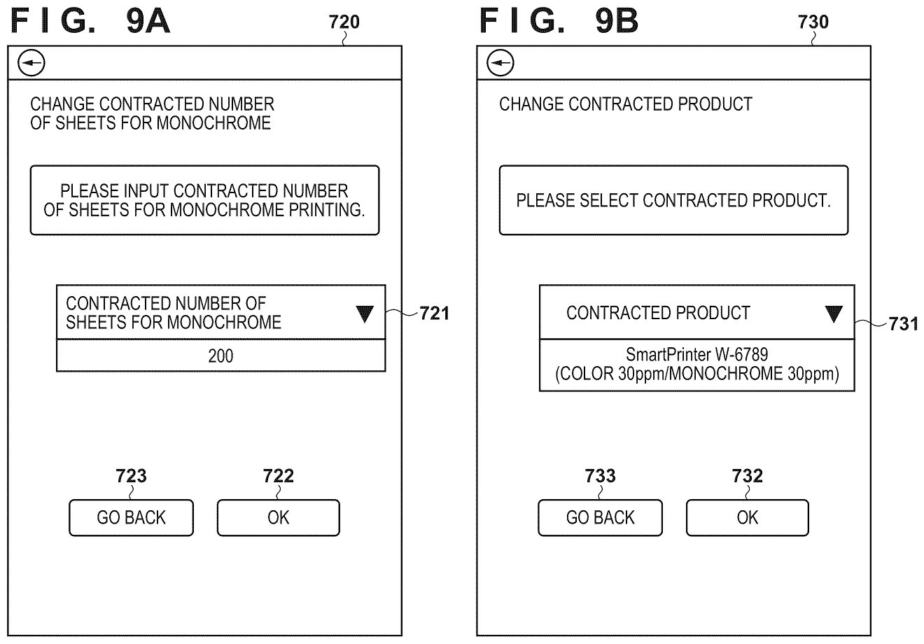

Further, in response to the user selecting a change contracted number of sheets for monochrome object 702 in the screen of FIG. 8A, in step S15 the user terminal 401 transmits a request for changing the contracted number of sheets for monochrome to the management server 301. In response to receiving the request for changing the contracted number of sheets for monochrome, in step S16 the management unit 350 of the management server 301 transmits a screen for changing contracted number of sheets for monochrome to the user terminal 401 and causes the user terminal 401 to display the screen. FIG. 9A indicates an example of a screen 720 for changing the contracted number of sheets for monochrome. By the user operating an object 721, which is a pull-down menu, options for the number of sheets available for contract are displayed, and the user selects a desired contracted number of sheets from the displayed options. In FIG. 9A, the user has selected 200 sheets as the changed contracted number of sheets for monochrome. Then, in response to the user operating an object 722, in step S17 the user terminal 401 notifies the management server 301 of information indicating the changed contracted number of sheets for monochrome. Configuration may be taken such that when the changed contracted number of sheets for monochrome is the same as the contracted number of sheets for monochrome before the change, the user terminal 401 notifies the user that the contracted number of sheets has not been changed in response to an operation of the object 722. In this case, the user terminal 401 may display the screen of FIG. 9A without notifying the management server 301 of the information indicating the changed contracted number of sheets for monochrome. Further, when the user operates an object 723, the user terminal 401 display the screen of FIG. 8A without notifying the management server 301 of the information indicating the changed contracted number of sheets for monochrome.

In step S18, the processing unit 360 of the management server 301 changes the “contracted number of sheets for monochrome” of the account table 320. In addition, the processing unit 360 updates “number of available pages (monochrome)” of the print data table 340 accordingly. When the update of the account table 320 and the print data table 340 by the processing unit 360 is completed, in step S19 the management unit 350 of the management server 301 makes a change completion notification to the user terminal 401. Such a notification includes information to be displayed on the screen of FIG. 8A based on the changed contract contents. Upon receiving the change completion notification from the management server 301, the user terminal 401 may display the contract change screen 700 based on the information received in the change completion notification. In the contracted number of sheets for monochrome of the contract change screen 700, the changed contracted number of sheets, that is, 200 sheets in the above example, is displayed.

Further, in response to the user selecting a change contracted product object 703 in the screen of FIG. 8A, in step S20 the user terminal 401 transmits a request for changing the contracted product to the management server 301. In response to receiving the request for changing the contracted product, in step S21 the management unit 350 of the management server 301 transmits a screen for changing the contracted product to the user terminal 401 and causes the user terminal 401 to display the screen. FIG. 9B indicates an example of a contracted product change screen 730. By the user operating an object 731, which is a pull-down menu, options for the type of the image forming apparatus 1 available in the service are displayed. The user selects a changed type (model) of the image forming apparatus 1 to be used in the service from the displayed options. Configuration may be taken so as to display, for the available options for the image forming apparatus 1, information indicating a printing speed (number of pages that can be printed per unit time) as reference information, as illustrated in FIG. 9B. The user can reference the printing speed when selecting the model to be used in the service.

Further, configuration may be taken such that the management unit 350 of the management server 301 displays a recommended model as an option based on the contracted number of sheets for color and the contracted number of sheets for monochrome at that time. For example, the management unit 350 of the management server 301 stores a combination of the recommended model and a combination of the contracted number of sheets for color and the contracted number of sheets for monochrome. Configuration may be taken such that the greater the contracted number of sheets, the faster the printing speed of the model to be recommended. In FIG. 9B, the user has selected a model named SmartPrinter W-6789 as the changed image forming apparatus 1.

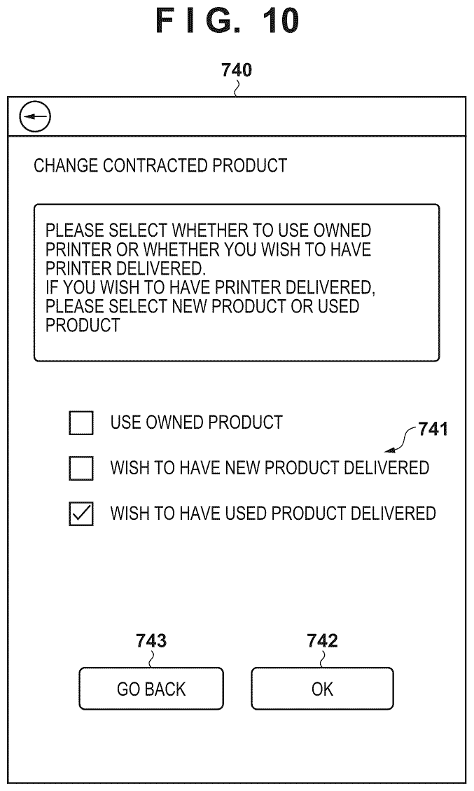

In response to the user operating an object 732 of FIG. 9B, the user terminal 401 displays a contracted product change screen 740 illustrated in FIG. 10. Configuration may be taken such that when the changed type of the image forming apparatus 1 is the same as the type of the image forming apparatus 1 before the change, the user terminal 401 notifies the user that the contracted product has not been changed in response to an operation of the object 732. In this case, the user terminal 401 may display the screen of FIG. 9B without transitioning to the screen of FIG. 10. When the user operates an object 733, the user terminal 401 displays the screen of FIG. 8A.

As illustrated in FIG. 10, in the contracted product change screen 740, the user can select whether the changed image forming apparatus 1 needs to be delivered. Specifically, as illustrated in FIG. 10, when the user themselves arranges the changed image forming apparatus 1, the user selects “use owned product” in an object 741. Meanwhile, when the user wants to newly receive the changed image forming apparatus 1 from the service provider, the user selects “wish to have new product delivered” or “wish to have used product delivered” in the object 741. “Wish to have new product delivered” is an option for requesting the service provider to provide a new image forming apparatus 1, and “wish to have used product delivered” is an option for requesting the service provider to provide a used image forming apparatus 1. The used image forming apparatus 1 may include a remanufactured model of the image forming apparatus 1 in which the recycled components are used in consideration of the environment. For example, configuration may be taken such that, by use of a used product, rental or lease cost is made lower than that for when a new product is used. In addition, if the rental or lease cost is not charged separately but is reflected in a per-predetermined period flat rate that accords with the contracted number of sheets, configuration may be taken such that by use of a used product, the amount charged per predetermined period is made lower than that for when a new product is used even if the contracted number of sheets is the same.

In response to the user operating an object 742 in the screen of FIG. 10, in step S22 the user terminal 401 notifies the management server 301 of information indicating the changed image forming apparatus 1 and a selection result of the object 741 by the user. In step S23, the processing unit 360 of the management server 301 adds information related to the changed image forming apparatus 1 to the apparatus registration table 330. In the “status” of the apparatus registration table 330, “unverified” is stored. In addition, if the user wishes to have the changed image forming apparatus 1 delivered, the management unit 350 of the image forming apparatus 1 starts processing necessary for delivery. Then, when the management unit 350 determines through an operation of the user terminal 401 by the user that communication between the management server 301 and the changed image forming apparatus 1 is possible, the processing unit 360 changes the “status” of the changed image forming apparatus 1 to “verified”. Further, the processing unit 360 deletes the information related to the image forming apparatus 1 before the change from the apparatus registration table 330. In this way, the change of the service target image forming apparatus is not immediately reflected in the processing of step S23 but is reflected after the completion of the verification of the changed image forming apparatus 1 by the management server 301. Therefore, until the completion of the verification of the changed image forming apparatus 1 by the management server 301, the image forming apparatus 1 before the change can be used.

In the present embodiment, a screen (FIG. 9B) for selecting the changed image forming apparatus 1 and a screen (FIG. 10) for selecting a method of arranging the changed image forming apparatus 1 are assumed as separate screens. However, it is also possible to configure the contracted product change screen so that the user can input the changed image forming apparatus 1 and the arrangement method thereof on the same screen.

In the sequence of FIG. 7 and examples of screens of FIGS. 8A, 8B, 9A, 9B, and 10, the changed contracted number of sheets for color, contracted number of sheets for monochrome, and image forming apparatus 1 are inputted by the user on different screens and are individually transmitted to the management server 301. However, for example, configuration may be taken such that both the changed contracted number of sheets for color and contracted number of sheets for monochrome are inputted by the user in one screen, and both the changed contracted number of sheets for color and contracted number of sheets for monochrome are simultaneously transmitted to the management server 301. In this case, the user terminal 401 transmits a request for changing the contracted number of sheets, and as a response thereto, the management server 301 performs processing for displaying, on the user terminal 401, a screen configured to allow input of both the changed contracted number of sheets for color and contracted number of sheets for monochrome. Further, configuration may be taken such that the changed contracted number of sheets for color, contracted number of sheets for monochrome, and model are inputted by the user in one screen, and these changed contents are collectively transmitted to the management server 301. In this case, the user terminal 401 transmits a change request, and as a response thereto, the management server 301 performs processing for displaying, on the user terminal 401, a screen configured to allow input of all of the changed contracted number of sheets for color, contracted number of sheets for monochrome, and model.

In the example of FIG. 7, the user is allowed to change to an arbitrary contracted number of sheets at an arbitrary timing. However, configuration may be taken so as to provide a limitation to the change of the contracted number of sheets. For example, configuration may be taken so as to provide a limitation that the changed contracted number of sheets is applied not in the current month but from the next month or subsequent months. For example, configuration may be taken such that the changed contracted number of sheets is applied from the next month. Alternatively, configuration may be taken such that the month on which to start the application of the changed contracted number of sheets is designated by the user via the user terminal 401. In this case, in steps S12 and S17, the user terminal 401 transmits, to the management server 301, information indicating an application start timing indicating the month in which to apply the change in addition to the changed contracted number of sheets. The processing unit 360 stores the changed contracted number of sheets and changes the “contracted number of sheets for color” and the “contracted number of sheets for monochrome” of the account table 320 at the start timing, which is the month on which to apply the changed contracted number of sheets. When the changed contracted number of sheets is not immediately applied, in steps S13 and S18, the processing unit 360 does not update the account table 320 and the print data table 340. Further, for example, configuration may be taken such that a change to a contracted number of sheets greater than the current contracted number of sheets can be applied immediately, but a change to a contracted number of sheets less than the current contracted number of sheets is applied from the next month or subsequent months. Further, configuration may be taken so as to provide a limitation that the number of changes is within a predetermined number of times when applying the changed contracted number of sheets in the current month.

Further, configuration may be taken such that upon receiving a change request from the user terminal 401 in steps S10, S15, S20, and the like, the management unit 350 transmits an email message indicating the reception of the change request with the “email address” of the account table 320 as the destination. In this case, if an affirmative response, that is, a response indicating that the user has transmitted the change request from the user terminal 401, is received as a response to the transmitted email, the management unit 350 transmits a change screen in steps S11, S16, and S21. Meanwhile, if a response to the email is not received or if a negative response, that is, a response indicating that the user has not transmitted the change request from the user terminal 401, is received, the management unit 350 does not transmit a change screen. Configuration may be taken such that if a negative response is received as a response to the email, the change screen is not transmitted, and if a response to the email is not received or an affirmative response is received, the change screen is transmitted. With this configuration, it is possible to enhance security related to a change of contract contents.

As a message indicating the reception of a change request, a short message service (SMS) or rich communication service (RCS) message can be used instead of an email. In this case, the “mobile phone number” of a mobile communication terminal used by the user is registered in the account table 320 instead of the “email address.” The “mobile phone number” is destination information indicating a destination of messages to the user.

The sequence of FIG. 7 and the examples of the screens of FIGS. 8A to 10 can also be applied to new registration processing (initial registration) at the start of a contract. In this case, “change” in the sequence of FIG. 7 and the examples of the screens of FIGS. 8A to 10 is, for example, “register”. Further, in the screen corresponding to FIG. 8A displayed first, the contracted number of sheets for color, the contracted number of sheets for monochrome, and the contracted product are all displayed as unregistered.

As described above, according to the present embodiment, the user can flexibly change contract contents related to the contracted number of sheets for color, the contracted number of sheets for monochrome, and the contracted product. With this, usability is improved.

### Second Embodiment

Next, a second embodiment will be described focusing on differences from the first embodiment. In the first embodiment, the contracted number of sheets for color and the contracted number of sheets for monochrome are set individually. In the present embodiment, one contracted number of sheets is managed without distinguishing between color and monochrome. For example, in the account table 320, the “contracted number of sheets” may be stored instead of the “contracted number of sheets for color” and the “contracted number of sheets for monochrome” of the first embodiment.

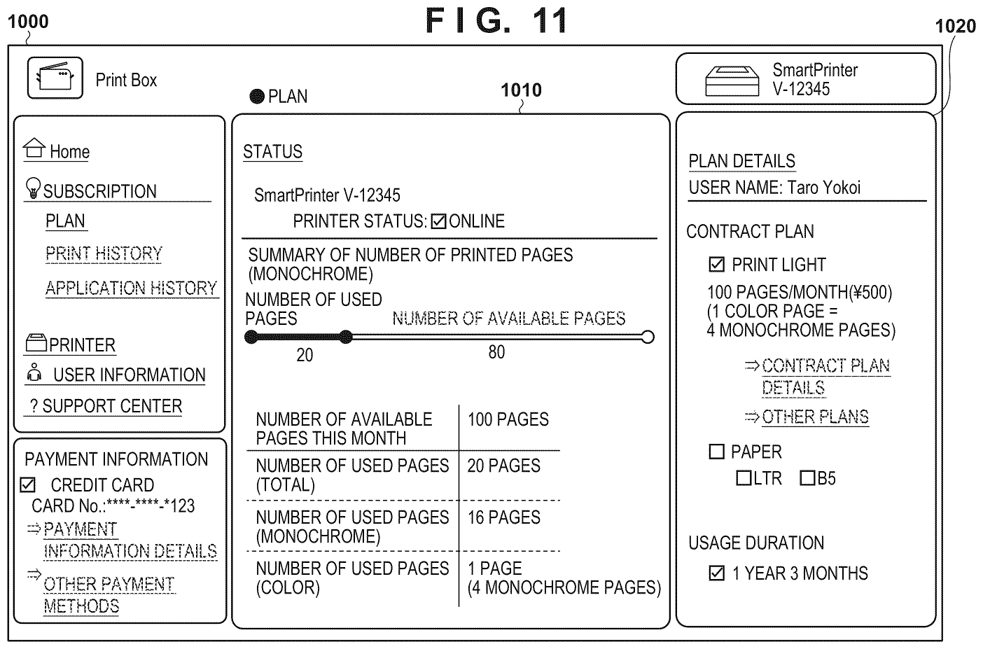

FIG. 11 illustrates an example of a screen 1000 provided by the management server 301 and displayed on the display unit of the user terminal 401, and corresponds to FIG. 6 of the first embodiment. The screen 1000 includes regions 1010 and 1020. The region 1010 displays information of items included in the apparatus registration table 330 and the print data table 340. The region 1020 displays information of items included in the account table 320.

The region 1020 indicates that in the current contract plan, the contracted number of sheets is 100 sheets per month, and color printing is counted as four sheets of monochrome printing. Further, the screen 1000 indicates that 16 sheets of monochrome printing and one sheet of color printing have already been performed, and accordingly, the total number of printed sheets is 20 sheets, and the remaining number of sheets to be printed is 80 sheets. That is, according to the present embodiment, configuration may be taken such that the print data table 340 of the management server 301 stores, as the number of sheets printed in color using the target image forming apparatus in the predetermined period, the number of sheets obtained by weighting the number of sheets actually printed in color. In this case, the total number of printed sheets in which color and monochrome are not distinguished is obtained by the sum of the number of sheets printed in monochrome and the number of sheets obtained by weighting the number of sheets printed in color. Configuration may be taken such that the print data table 340 of the management server 301 stores the number of sheets printed in monochrome and the number of sheets printed in color using the target image forming apparatus in a predetermined period. In this case, the total number of printed sheets in which color and monochrome are not distinguished is obtained by the sum of the number of sheets printed in monochrome and the number of sheets obtained by weighting the number of sheets printed in color.

As described above, according to the present embodiment, the contracted number of sheets is set without distinguishing between monochrome printing and color printing. Therefore, usability is improved, such as a case where even if color prints in the predetermined period increase from what is usual, if monochrome prints in the predetermined period are low, it is possible to keep the number of printed sheets within the contracted number of sheets, for example. In the above example, one sheet of color printing is weighted by a coefficient of 4, and thus, one sheet of color printing is counted as four sheets of monochrome printing. However, the value of the weighting coefficient, that is, the number of sheets of monochrome printing to be counted as one sheet of color printing can be arbitrarily set. Further, configuration may be taken such that a plurality of contract plans whose number of sheets of monochrome printing corresponding to one sheet of color printing are different are provided, and the user makes a selection.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-175546, filed Oct. 10, 2023, which is hereby incorporated by reference herein in its entirety.

What is claimed is:

1. A server apparatus configured to manage an image forming apparatus, the server apparatus comprising:
a storage unit configured to store information indicating a target image forming apparatus used by a user, information indicating a first maximum number of sheets that can be printed in color during a predetermined period using the target image forming apparatus, information indicating a second maximum number of sheets that can be printed in monochrome during the predetermined period using the target image forming apparatus, information indicating the number of sheets printed in color using the target image forming apparatus in the predetermined period, and information indicating the number of sheets printed in monochrome using the target image forming apparatus in the predetermined period; and
a processing unit configured to, in response to a first request for changing at least one of the first maximum number of sheets and the second maximum number of sheets received from a terminal used by the user, perform change processing for changing the at least one of the first maximum number of sheets and the second maximum number of sheets.

2. The server apparatus according to claim 1, wherein
the processing unit is configured to, in response to receiving the first request from the terminal, perform processing for displaying, on the terminal, a screen for inputting information indicating a changed maximum number of sheets of the at least one of the first maximum number of sheets and the second maximum number of sheets.

3. The server apparatus according to claim 2, wherein
the screen for inputting the information indicating the changed maximum number of sheets indicates an option for the changed maximum number of sheets.

4. The server apparatus according to claim 2, wherein
the storage unit stores destination information of a message to the user, and
the processing unit is configured to, in response to receiving the first request from the terminal, transmit a message indicating that the first request has been received to a destination indicated by the destination information and, upon receiving an affirmative response to the transmitted message, perform the processing for displaying, on the terminal, the screen for inputting the changed maximum number of sheets.

5. The server apparatus according to claim 1, wherein
the processing unit is configured to, in response to a second request for changing the target image forming apparatus received from the terminal, perform processing for changing the target image forming apparatus.

6. The server apparatus according to claim 5, wherein
the processing unit is configured to, in response to receiving the second request from the terminal, perform processing for displaying, on the terminal, a screen for inputting information indicating a changed target image forming apparatus.

7. The server apparatus according to claim 6, wherein
the screen for inputting the information indicating the changed target image forming apparatus indicates an option for the changed target image forming apparatus.

8. The server apparatus according to claim 6, wherein
the screen for inputting the information indicating the changed target image forming apparatus indicates an option as to whether the changed target image forming apparatus needs to be delivered to the user.

9. The server apparatus according to claim 8, wherein
in a case where the changed target image forming apparatus needs to be delivered to the user, the screen for inputting the information indicating the changed target image forming apparatus indicates an option for which of a new product and a used product to deliver.

10. A server apparatus operable to manage an image forming apparatus, the server apparatus comprising:
a storage unit configured to store information indicating a target image forming apparatus used by a user, information indicating a maximum number of sheets that can be printed during a predetermined period using the target image forming apparatus, information indicating the number of sheets printed in color using the target image forming apparatus in the predetermined period, and information indicating the number of sheets printed in monochrome using the target image forming apparatus in the predetermined period; and
a processing unit configured to, in response to a first request for changing the maximum number of sheets received from a terminal used by the user, perform processing for changing the maximum number of sheets,
wherein
the storage unit is configured to store, as the number of sheets printed in color using the target image forming apparatus in the predetermined period, the number of sheets obtained by weighting the number of sheets actually printed in color using the target image forming apparatus in the predetermined period.

11. The server apparatus according to claim 10, wherein
the processing unit is configured to, in response to receiving the first request from the terminal, perform processing for displaying, on the terminal, a screen for inputting information indicating a changed maximum number of sheets.

12. The server apparatus according to claim 11, wherein
the screen for inputting the information indicating the changed maximum number of sheets indicates an option for the changed maximum number of sheets.

13. The server apparatus according to claim 11, wherein
the storage unit stores destination information of a message to the user, and
the processing unit is configured to, in response to receiving the first request from the terminal, transmit a message indicating that the first request has been received to a destination indicated by the destination information and, upon receiving an affirmative response to the transmitted message, perform the processing for displaying, on the terminal, the screen for inputting the changed maximum number of sheets.

14. The server apparatus according to claim 10, wherein
the processing unit is configured to, in response to a second request for changing the target image forming apparatus received from the terminal, perform processing for changing the target image forming apparatus.

15. The server apparatus according to claim 14, wherein
the processing unit is configured to, in response to receiving the second request from the terminal, perform processing for displaying, on the terminal, a screen for inputting information indicating a changed target image forming apparatus.

16. The server apparatus according to claim 15, wherein
the screen for inputting the information indicating the changed target image forming apparatus indicates an option for the changed target image forming apparatus.

17. The server apparatus according to claim 15, wherein
the screen for inputting the information indicating the changed target image forming apparatus indicates an option as to whether the changed target image forming apparatus needs to be delivered to the user.

18. The server apparatus according to claim 17, wherein
in a case where the changed target image forming apparatus needs to be delivered to the user, the screen for inputting the information indicating the changed target image forming apparatus indicates an option for which of a new product and a used product to deliver.

19. A non-transitory computer-readable storage medium storing a computer program, which when executed by one or more processors of an apparatus including:
the one or more processors; and a memory configured to store information indicating a target image forming apparatus used by a user, information indicating a first maximum number of sheets that can be printed in color during a predetermined period using the target image forming apparatus, information indicating a second maximum number of sheets that can be printed in monochrome during the predetermined period using the target image forming apparatus, information indicating the number of sheets printed in color using the target image forming apparatus in the predetermined period, and information indicating the number of sheets printed in monochrome using the target image forming apparatus in the predetermined period, causes the one or more processors to:
in response to a first request for changing at least one of the first maximum number of sheets and the second maximum number of sheets received from a terminal used by the user, perform change processing for changing the at least one of the first maximum number of sheets and the second maximum number of sheets.

20. A non-transitory computer-readable storage medium storing a computer program, which when executed by one or more processors of an apparatus comprising:
the one or more processors; and a memory configured to store information indicating a target image forming apparatus used by a user, information indicating a maximum number of sheets that can be printed during a predetermined period using the target image forming apparatus, information indicating the number of sheets printed in color using the target image forming apparatus in the predetermined period, and information indicating the number of sheets printed in monochrome using the target image forming apparatus in the predetermined period, causes the one or more processors to: in response to a first request for changing the maximum number of sheets received from a terminal used by the user, perform change processing for changing the maximum number of sheets, wherein the computer program causes the one or more processors to:
store, in the memory, as the number of sheets printed in color using the target image forming apparatus in the predetermined period, the number of sheets obtained by weighting the number of sheets actually printed in color using the target image forming apparatus in the predetermined period.

21. A management system comprising:
a server apparatus configured to manage an image forming apparatus; and
the image forming apparatus configured to be capable of communicating with the server apparatus,
wherein
the server apparatus includes:
a storage unit configured to store information indicating a target image forming apparatus used by a user, information indicating a first maximum number of sheets that can be printed in color during a predetermined period using the target image forming apparatus, information indicating a second maximum number of sheets that can be printed in monochrome during the predetermined period using the target image forming apparatus, information indicating the number of sheets printed in color using the target image forming apparatus in the predetermined period, and information indicating the number of sheets printed in monochrome using the target image forming apparatus in the predetermined period; and
a processing unit configured to, in response to a first request for changing at least one of the first maximum number of sheets and the second maximum number of sheets received from a terminal used by the user, perform change processing for changing the at least one of the first maximum number of sheets and the second maximum number of sheets.

22. A management system comprising:
a server apparatus configured to manage an image forming apparatus; and
the image forming apparatus configured to be capable of communicating with the server apparatus,
wherein
the server apparatus includes:
a storage unit configured to store information indicating a target image forming apparatus used by a user, information indicating a maximum number of sheets that can be printed during a predetermined period using the target image forming apparatus, information indicating the number of sheets printed in color using the target image forming apparatus in the predetermined period, and information indicating the number of sheets printed in monochrome using the target image forming apparatus in the predetermined period; and
a processing unit configured to, in response to a first request for changing the maximum number of sheets received from a terminal used by the user, perform processing for changing the maximum number of sheets,
wherein
the storage unit is configured to store, as the number of sheets printed in color using the target image forming apparatus in the predetermined period, the number of sheets obtained by weighting the number of sheets actually printed in color using the target image forming apparatus in the predetermined period.
